(19) United States
(12) Patent Application Publication
(10) Pub. No.: US 2024/0370801 A1
(43) Pub. Date: Nov. 7, 2024

(54) SYSTEM AND METHOD OF PREDICTING CATASTROPHIC INCIDENTS IN A SERVICE SYSTEM

(71) Applicant: Wipro Limited, Bangalore (IN)

(72) Inventors: Anindito DE, Chennai (IN); Dipojjwal GHOSH, Kolkata (IN); Soumya TALUKDER, Hooghly (IN); Sahithi BAGAM, Hyderabad (IN); Siladitya SEN, Kolkata (IN)

(21) Appl. No.: 18/337,895

(22) Filed: Jun. 20, 2023

(30) Foreign Application Priority Data
May 2, 2023 (IN) 202341031352

(51) Int. Cl. G06Q 10/0635

(52) U.S. Cl. CPC G06Q 10/0635

(57) ABSTRACT

Disclosed herein an incident prediction system and a method for predicting catastrophic incidents in a service system. The system receives one or more tickets for one or more services along with information of the one or more tickets. Further, the system identifies a set of tickets for each of a predefined event window and a predefined non-event window from the one or more tickets and identifies a set of words for each of the set of tickets using a prediction model. Furthermore, the system identifies cluster data for each set of tickets from pre-defined clusters using a ticket clustering model and identifies presence of one or more sequence rules in cluster data. Finally, the system generates a risk score for each of the one or more services and root-causes for the set of tickets based on the one or more sequence rules, one or more parameters and creation time.

### TECHNICAL FIELD

The present disclosure, in general, relates to Artificial Intelligence (AI) based predicting systems, and particularly relates to a system and method of predicting catastrophic incidents in a service system.

### BACKGROUND

Information Technology Service Management (ITSM) plays an important role in ensuring continuous availability of one or more services relied on Information Technology (IT). ITSM operates by mechanizing reporting of customer issues and events to an IT team through tickets. The tickets may be raised in two conditions. The first condition may be due to unplanned interruptions in an IT ecosystem such as outages, errors, performance issues, and the like. The second condition may be due to assistance required for routine activities such as, requesting access, resetting passwords, updating data, provisioning services, and the like. The unplanned disruptions may cause a chain of failures. One or more actions related to the ITSM deal with reactive mechanism, i.e., responding to the post occurrence of a high severity incident. These high severity incidents cause system downtime and increase incurred cost.

Conventionally, existing systems incorporate various mechanisms based on log filtering, one or more techniques based on Ordering Points to Identify Clustering Structure (OPTICS) and Long Short Term Memory (LSTM) techniques along with formatted texts associated with console logs of the IT system, similarity score techniques, Local interpretable Model-agnostic Explanation (LIME) based interpretability, and analysis such as cluster time analysis to predict system failure or to provide network operators timely warnings against faulty conditions or to determine a root-cause of a failure in the IT system. However, these existing techniques do not include mechanisms to identify catastrophic incidents and probability of occurrence of the catastrophic incidents for multiple services based on individual patterns with respect to each service. Further, these techniques do not consider sequence of events for root cause identification with respect to the catastrophic incident.

The information disclosed in this background of the disclosure section is only for enhancement of understanding of the general background of the invention and should not be taken as an acknowledgement or any form of suggestion that this information forms the prior art already known to a person skilled in the art.

### SUMMARY

Disclosed herein is a method of predicting catastrophic incidents in a service system. The method comprises receiving, by an incident prediction system, one or more tickets for one or more services associated with the service system along with information of each of the one or more tickets, from one or more sources. Further, the method comprises identifying, by an incident prediction system, a set of tickets for each of a predefined event window and a predefined non-event window from the one or more tickets, for each of the one or more services. The predefined event window and the predefined non-event window are each indicative of a time period comprising the set of tickets occurring prior to occurrence of high severity tickets and low severity tickets, respectively. Further, the method comprises identifying, by an incident prediction system, a set of words for each of the set of tickets, for each of the predefined event window and the predefined non-event window; based on the information corresponding to the respective set of tickets using a prediction model. Further, the method comprises identifying, by the incident prediction system, cluster data for each set of tickets from pre-defined clusters by correlating information associated with the pre-defined clusters with the set of words respective to each of the set of tickets, using a ticket clustering model. Further, the method comprises identifying, by the incident prediction system, presence of one or more sequence rules in the cluster data for each of the set of tickets based on occurrence of one or more predefined patterns corresponding to predefined sequence rules. Thereafter, the method comprises generating, by the incident prediction system, a risk score for each of the one or more services and one or more root-causes for the set of tickets based on the one or more sequence rules, one or more parameters of historical tickets and creation time of the one or more tickets. The catastrophic incidents are predicted based on the risk score and the one or more root-causes.

Further, the present disclosure relates to an incident prediction system for predicting catastrophic incidents in a service system. The incident prediction system comprises a processor and a memory. The memory is communicatively coupled to the processor and stores processor-executable instructions, which on execution, cause the processor to receive one or more tickets for one or more services associated with the service system along with information of each of the one or more tickets, from one or more sources. The processor identifies a set of tickets for each of a predefined event window and a predefined non-event window from the one or more tickets, for each of the one or more services. The predefined event window and the predefined non-event window are each indicative of a time period comprising the set of tickets occurring prior to occurrence of high severity tickets and low severity tickets, respectively. Thereafter, the processor identifies a set of words for each of the set of tickets, for each of the predefined event window and the predefined non-event window, based on the information corresponding to the respective set of tickets using a prediction model. Furthermore, the processor identifies cluster data for each set of tickets from pre-defined clusters by correlating information associated with the pre-defined clusters with the set of words respective to each of the set of tickets, using a ticket clustering model. Further, the processor identifies presence of one or more sequence rules in the cluster data for each of the set of tickets based on occurrence of one or more predefined patterns corresponding to predefined sequence rules. Finally, the processor generates a risk score for each of the one or more services and one or more root-causes for the set of tickets based on the one or more sequence rules, one or more parameters of historical tickets and creation time of the one or more tickets. The catastrophic incidents are predicted based on the risk score and the one or more root-causes.

In some embodiments, the present disclosure relates to a method for training a prediction model for predicting catastrophic incidents in a service system. The method comprises collecting, by the incident prediction system, one or more training parameters of a plurality of historical tickets for one or more services associated with the service systems, from one or more sources. Further, the method comprises identifying, by the incident prediction system, a set of historical tickets corresponding to an event window and a non-event window for each service of the one or more services, from the plurality of historical tickets. The set of historical tickets comprises high severity historical tickets and low severity historical tickets. Further, the method comprises identifying, by the incident prediction system, a set of words for each of the set of historical tickets for each service based on the one or more training parameters corresponding to each set of historical tickets using Natural Language Processing (NLP) techniques. Further, the method comprises generating, by the incident prediction system, training clusters from the set of words corresponding to the set of historical tickets for each service. Further, the method comprises generating, by the incident prediction system, training sequence rules based on chronological patterns of the training clusters impacting occurrence of the high severity historical tickets, for each service, using one or more mining techniques. Thereafter, the method comprises generating, by the incident prediction system, an impact score for each of the training sequence rules using a predefined machine learning technique. The impact scores is indicative of a value of each of the trained sequence rules for promoting or demoting the occurrence of the high severity historical tickets.

Further, the present disclosure relates to an incident prediction system for training the prediction model for prediction of catastrophic incidents in a service system. The incident prediction system comprises a processor and a memory. The memory is communicatively coupled to the processor and stores processor-executable instructions, which on execution, cause the processor to collect one or more training parameters of a plurality of historical tickets for the one or more services associated with the service systems, from one or more sources. Further, the processor identifies a set of historical tickets corresponding to an event window and a non-event window for each service of the one or more services, from the plurality of historical tickets. The set of historical tickets comprises high severity historical tickets and low severity historical tickets. Further, the processor generates training sequence rules based on chronological patterns of the training clusters impacting occurrence of the high severity historical tickets, for each service, using one or more mining techniques. Thereafter, the processor generates an impact score for each of the training sequence rules using a predefined machine learning technique. The impact scores is indicative of a value of each of the trained sequence rules for promoting or demoting the occurrence of the high severity historical tickets.

Further, the present disclosure relates to a non-transitory computer readable medium including instruction stored thereon that when processed by at least one processor may cause an incident prediction system receives one or more tickets for one or more services associated with the service system along with information of each of the one or more tickets, from one or more sources. The instruction causes the processor to identify a set of tickets for each of a predefined event window and a predefined non-event window from the one or more tickets, for each of the one or more services. The predefined event window and the predefined non-event window are each indicative of a time period comprising the set of tickets occurring prior to occurrence of high severity tickets and low severity tickets, respectively. The instruction causes the processor to identify a set of words for each of the set of tickets, for each of the predefined event window and the predefined non-event window, based on the information corresponding to the respective set of tickets using a prediction model. The instruction causes the processor to identify cluster data for each set of tickets from pre-defined clusters by correlating information associated with the pre-defined clusters with the set of words respective to each of the set of tickets, using a ticket clustering model. The instruction causes the processor to identify presence of one or more sequence rules in the cluster data for each of the set of tickets based on occurrence of one or more predefined patterns corresponding to predefined sequence rules using a mining model. The instruction causes the processor to generate a risk score for each of the one or more services and one or more root-causes for the set of tickets based on the one or more sequence rules, one or more parameters of historical tickets and creation time of the one or more tickets. The catastrophic incidents is predicted based on the risk score and the one or more root-causes.

Further, the present disclosure relates to a non-transitory computer readable medium including instruction stored thereon that when processed by at least one processor cause an incident prediction system to collect one or more training parameters of a plurality of historical tickets for one or more services associated with the service systems, from one or more sources. The instruction causes the processor to identify a set of historical tickets corresponding to an event window and a non-event window for each service of the one or more services, from the plurality of historical tickets. The set of historical tickets comprises high severity historical tickets and low severity historical tickets. The event window and the non-event window are each indicative of a time period comprising historical tickets occurring prior to occurrence of the high severity historical tickets and the low severity historical tickets respectively. The time period is determined based on an inter-arrival time of the plurality of historical tickets. The instruction causes the processor to identify a set of words for each of the set of historical tickets for each service based on the one or more training parameters corresponding to each set of historical tickets using Natural Language Processing (NLP) techniques. The instruction causes the processor to generate training clusters from the set of words corresponding to the set of historical tickets for each service. The instruction causes the processor to generate training sequence rules based on chronological patterns of the training clusters impacting occurrence of the high severity historical tickets, for each service, using one or more mining techniques. The instruction causes the processor to generate an impact score for each of the training sequence rules using a predefined machine learning technique. The impact scores is indicative of a value of each of the trained sequence rules for promoting or demoting the occurrence of the high severity historical tickets.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference features and components. Some embodiments of system and/or methods in accordance with embodiments of the present subject matter are now described, by way of example only, and regarding the accompanying figures, in which:

FIG. 1 shows an exemplary environment for predicting catastrophic incidents in a service system, in accordance with some embodiments of the present disclosure;

FIG. 2 shows a detailed block diagram of an incident prediction system, in accordance with some embodiments of the present disclosure;

FIG. 3A-3C show exemplary User Interface (UI) representations for predicting catastrophic incidents in a service system, in accordance with some embodiments of the present disclosure:

FIG. 4A shows a flowchart illustrating a method for predicting catastrophic incidents in a service system, in accordance with some embodiments of the present disclosure;

FIG. 4B shows a flowchart illustrating a method for training models for predicting catastrophic incidents in a service system, in accordance with some embodiments of the present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however, that it is not intended to limit the disclosure to the specific forms disclosed, but on the contrary, the disclosure is to cover all modifications, equivalents, and alternative falling within the scope of the disclosure.

The terms “comprises”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

Information Technology Service Management (ITSM) plays an important role in ensuring the availability of one or more services relied on Information Technology (IT). Various interruptions may occur in an Information Technology (IT) system because of which a customer may report such interruptions via tickets. The tickets may be raised due to unplanned interruptions and interruptions due to routine activities. However, due to unplanned interruptions or catastrophic incidents, quality of services may be disrupted which may lead to failure in the IT system.

In order to solve the aforementioned technical problem, the present disclosure discloses a system and a method for predicting catastrophic incidents in a service system.

In some embodiments, the present disclosure predicts occurrence of catastrophic incidents for each service of the service system along with possible root-causes proactively before those catastrophic incidents occur based on a machine learning based approach. Particularly, historical tickets and one or more real-time tickets are utilized to detect complex recurring patterns of the catastrophic incidents and to provide an alert regarding occurrence of the catastrophic incidents proactively before actual occurrence to avoid disruption in the service system. The present disclosure includes machine learning models which are trained using multi-dimensional data from tickets across various services to seamlessly deduce complex underlying patterns to predict occurrence of high severity incidents in future timelines.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

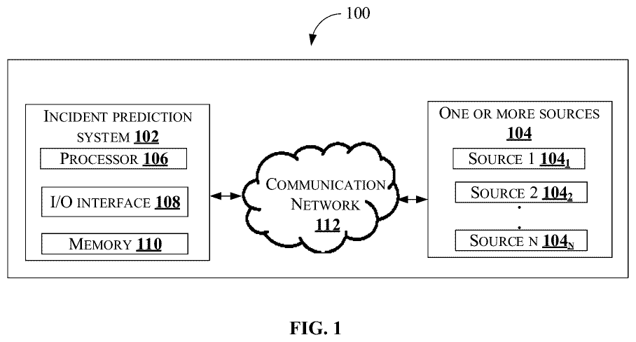

FIG. 1 shows an exemplary environment (100) for predicting catastrophic incidents in a service system, in accordance with some embodiments of the present disclosure.

As shown in FIG. 1, the environment (100) includes an incident prediction system (102) and one or more sources (104) (source 104₁-source 104N, collectively referred as one or more sources 104). The incident prediction system (102) predicts future occurrences of catastrophic incidents along with possible root-causes for one or more services in a service system proactively. The service system may refer to a system in an organization to provide and manage the one or more services provided by the organization. For example, the service system may include, but not limited to, management service, engineering service, operations service, and the like. Typically, the service system ensures continuous availability of the one or more services by utilizing a ticket-based mechanism to resolve issues associated with the one or more services. The one or more services of the service system may vary depending on the type of the service system. The one or more services may include, but not limited to, different services in an Information Technology Service Management (ITSM) such as Enterprise Resource Planning (ERP) system, maintenance system, board of management, development system, and the like. For example, issues associated with one or more of the above-mentioned services may include errors in marking attendance in the ERP system, issues with using one or more applications by the board of management during a software update, and the like. The incident prediction system (102) is connected with the one or more sources (104) via a communication network (112). The communication network (112) may be one of, a wired communication network, a wireless communication network or a combination of both wired and wireless communication network. The one or more sources (104) may include, but not limited to, a ticket database. The ticket database may include, but is not limited to, information associated with plurality of tickets for the one or more services associated with the service system.

The incident prediction system (102) may receive one or more tickets and the information associated with the one or more tickets from the one or more sources (104).

Upon receiving the one or more tickets, the incident prediction system (102) may identify a set of tickets for a predefined event window and a pre-defined non-event window, from the one or more tickets, for each of the one or more services. The predefined event window are indicative of a time period comprising the set of tickets occurring prior to occurrence of high severity tickets and the predefined non-event window are indicative of the time period comprising the set of tickets occurring prior to occurrence of low severity tickets.

Further, in order to determine significant meaning in the set of tickets, the incident prediction system (102) may identify a set of words for the set of tickets for each of the predefined event window and the predefined non-event window. The set of words for the predefined event window are related to high severity incident tickets. Similarly, the set of words for the predefined non-event window are related to low severity incident tickets. In an embodiment, the incident prediction system (102) may identify the set of words using Natural Language Processing (NLP) techniques using a prediction model. The NLP techniques may include, but are not limited to, text-preprocessing techniques, lemmatization, tokenization, and vectorization. The incident prediction system (102) may identify and remove unrelated terms in a ticket description for each of the set of tickets using the text-preprocessing techniques. In an embodiment, the unrelated terms may be selected based on terms generated by testing and validation of the one or more tickets or may be provided manually by domain experts. In an embodiment, these unrelated terms may be prestored in the one or more sources (104). Further, the incident prediction system (102) may process the ticket description for each of the set of tickets using the lemmatization and the tokenization to obtain the set of words for each of the set of tickets. Thereafter, the incident prediction system (102) may process the set of words using the vectorization to obtain significant meaning of the set of words.

Further, the incident prediction system (102) may determine cluster data for the set of tickets for each of the predefined event window and the predefined non-event window using a ticket clustering model. For example, the set of words associated with high severity incident tickets are clustered into a first cluster. Similarly, the set of words associated with low severity incident tickets are clustered into a second cluster. The cluster data may be determined by correlating information associated with predefined clusters with the set of words associated with the set of tickets using a ticket clustering model based on one or more clustering techniques. The one or more clustering techniques may include, but not limited to, k-means clustering. Particularly, the incident prediction system (102) may correlate the information associated with the predefined clusters by calculating a pair-wise cosine distance for each of the set of words with centroids of each of the predefined clusters, determining a minimum cosine distance and identifying the cluster data from the predefined clusters based on the minimum cosine distance. The minimum cosine distance may be identified by correlating the pair-wise cosine distance for each of the set of words with the centroids of each of the predefined clusters.

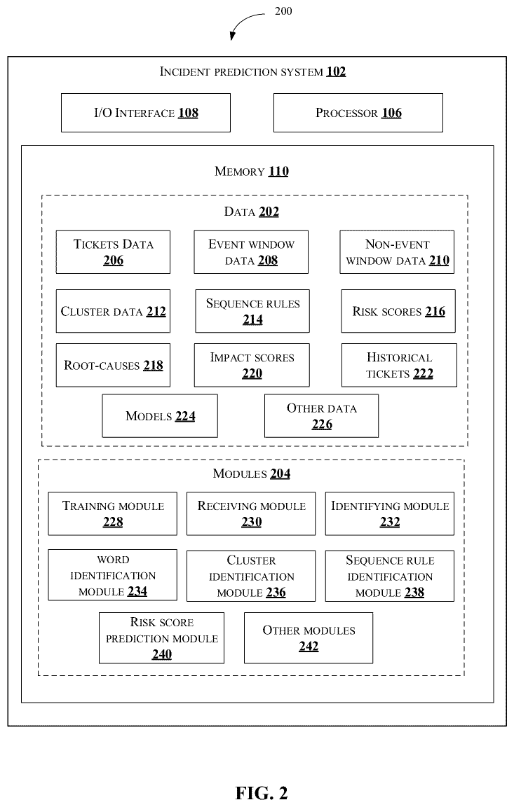

Upon determining the cluster data for the set of tickets, one or more sequence rules may be identified to determine a set of events leading to a high severity incident or a low severity incident. For example, consider a pattern such as AABCDA which precedes a high severity incident, where A, B, C, D are clusters containing information for set of tickets leading to the high severity incident. In such a case, the sequence rules may be of the form AABCDA. Herein, to identify a presence of the one or more sequence rules in the cluster data, the incident prediction system (102) may identify occurrence of one or more predefined patterns corresponding to predefined sequence rules using a mining model by correlating the predefined sequence rules with the information of the predefined clusters. Detailed explanation of the determination of the predefined clusters and identification of the predefined sequence rules is explained in FIG. 2.

Thereafter, the incident prediction system (102) may generate a risk score for each of the one or more services and the root-causes for the set of tickets based on the one or more sequence rules, one or more parameters of historical tickets and creation time of the one or more tickets to predict the catastrophic incidents. The risk score may provide a probability value of occurrence of the high severity incident and the root-causes may determine the causes of occurrence of the high severity incident that may lead to the catastrophic incident. For example, if the risk score for a service A associated with the high severity incident ticket is comparatively higher than a risk score for a service B associated with the low severity incident ticket, it may be inferred that the service A has higher changes of leading to the catastrophic incidents.

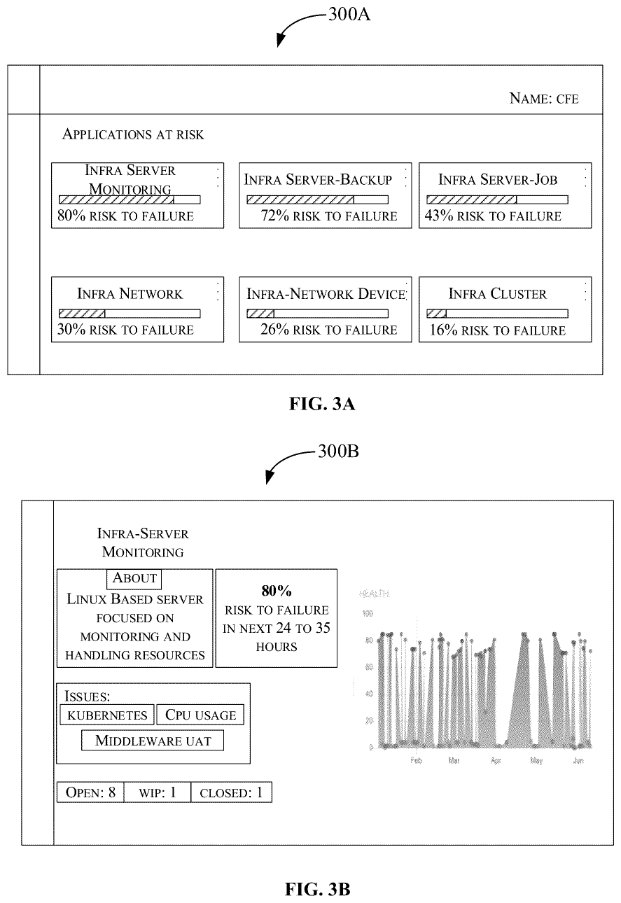

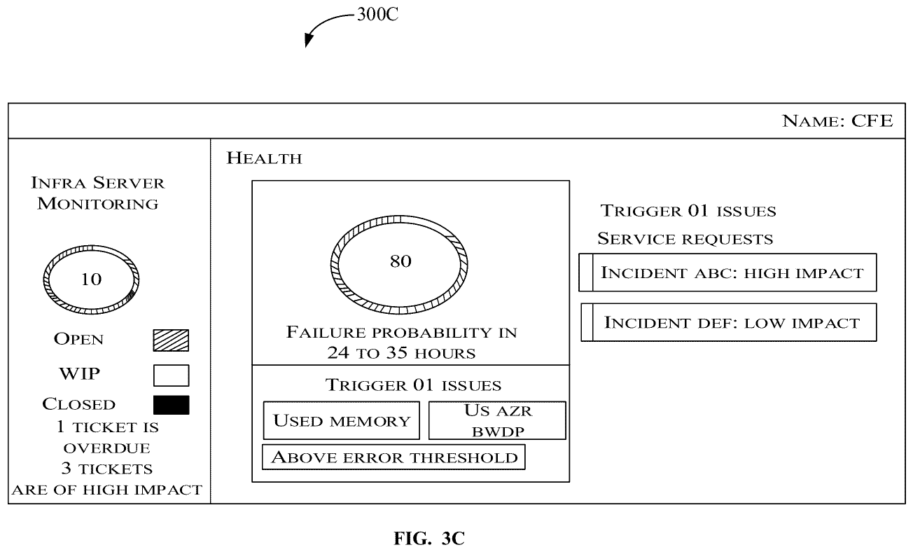

In some embodiments, the incident prediction system (102) may include a processor (106), an Input/Output (I/O) Interface (108) and a memory (110). Detailed explanation of determining the catastrophic incidents and their root-causes based the aforementioned components is explained in FIG. 2 and FIG. 3A-3B.

In some embodiments, the one or more models (such as, the prediction model, the ticket clustering model, and the mining model, not shown in FIG. 2) may be trained in order to determine the set of words for the set of tickets, predefined clusters, predefined sequence rules, and impact scores to determine the catastrophic incidents and their root-causes, respectively for each service. In some embodiments, the one or more models are related to a Machine Learning (ML) model. Detailed explanation of determining the catastrophic incidents and their root-causes is explained in FIG. 2 and FIG. 3A-3B.

FIG. 2 shows a detailed block diagram of an incident prediction system (102), in accordance with some embodiments of the present disclosure.

The incident prediction system (102) may include a processor (106), an I/O interface (108) and a memory (110). The I/O interface (108) may be configured for receiving and transmitting an input signal or/and an output signal related to one or more operations of the incident prediction system (102). The memory (110) may be communicatively coupled to the processor (106) and one or more modules (204). The processor (106) may be configured to perform one or more functions of the incident prediction system (102) for predicting catastrophic incidents using data (202) and the one or more modules (204).

In an embodiment, the data (202) stored in the memory (110) may include without limitation, ticket data (206), event window data (208), non-event window data (210), cluster data (212), sequence rules (214), risk scores (216), root-causes (218), impact scores (220), historical tickets (222), one or more models (224) and other data (226). In some implementations, the data (202) may be stored within the memory (110) in the form of various data structures. Additionally, the data (202) may be organized using data models. The other data (226) may include temporary data and files generated by the different components or modules for performing various functions of the incident prediction system (102).

In some embodiments, the ticket data (206) may include one or more tickets and information associated with the one or more tickets. The one or more tickets may be received from one or more sources (104). The information associated with the one or more tickets include, but not limited to, severity information of the one or more tickets, identification number of ticket, type of service associated with the one or more tickets, ticket description, complaint Identifier (ID), operator details related to assignment of ticket, creation time of the one or more tickets, and the like. In some instance, for example, information of ticket A discloses that the ticket A is of medium severity, identification number of the ticket A is “4”, type of service for the ticket A is updating of passwords in an ERP system, complaint identifier for ticket A is “425” and creation time of the ticket A is 4 pm on 5 Dec. 2022. In some other instance, for example, information of ticket B discloses that the ticket B is of low severity, identification number of the ticket B is “7”, type of service for the ticket B is marking attendance in the ERP system, complaint identifier for ticket A is “226” and creation time of the ticket B is 7 pm on 19 Jan. 2023.

In some embodiments, the event window data (208) may include the set of tickets and the set of words associated with high severity tickets. The set of tickets associated with the high severity tickets may be identified based on severity information associated with the one or more tickets. For example, a ticket may be raised because of a system failure in the ERP system, then in such a case this incident is termed as a high severity incident. Further, in this case, the set of words are identified based on deployment, system failure, and the like.

In some embodiments, the non-event window data (210) may include the set of tickets and the set of words associated with low severity tickets. The set of tickets associated with the low severity tickets may be identified based on severity information associated with the one or more tickets. For example, a ticket may be raised because of not being able to mark attendance in the ERP system due to regular maintenance of the system, then in such a case this incident is termed as a low severity incident. Further, based on the above example, the set of words for the low severity incidents may be based on testing, routine checks, and the like.

In some embodiments, the cluster data (212) includes significant information for the set of tickets determined by using one or more clustering techniques.

In some embodiments, the sequence rules (214) may provide one or more rules associated with the set of tickets based on one or more patterns in the cluster data (212) using one or more mining techniques. For example, consider a pattern such as AABCCEE which precedes a high severity incident 1, where A, B, C, E are cluster which contains information associated to the high severity incident 1. In such a case, the sequence rules may be of the form AABCCEE and provide a significance that sequential occurrence of ABCE which may lead to the high severity incident 1.

In some embodiments, the risk scores (216) may include a probability value of occurrence of a high severity incidents based on one or more parameters of the historical tickets (222), and creation time of the one or more tickets.

In some embodiments, the root-causes (218) are set of possible causes of the set of tickets determined based on the one or more sequence rules (214). For example, if ticket A succeeds the sequence rules (214) of the form BCD, then, the possible causes for the ticket A is based on information present in the sequence rule of the form BCD.

In some embodiments, the impact scores (220) may include predefined impact scores generated for the historical tickets (222). The impact scores (220) may indicate a value of each of the predefined sequence rules in promoting or demoting the occurrence of high severity historical tickets, for each service.

In some embodiments, the historical tickets (222) include training tickets for one or more services.

In some embodiments, the one or more models (224) may include, a prediction model, a ticket clustering model and a mining model. The one or more models (224) may be trained using one or more training parameters to determine the cluster data (212), the sequence rules (214), and the risk scores (216), respectively, in order to predict occurrence of the catastrophic incidents in a service system. In some embodiments, the one or more training parameters associated with the historical tickets (222) may include, but not limited to, severity information of the historical tickets (222), the identification number of the historical tickets (222), the type of service associated with the historical tickets (222), the ticket description, the complaint Identifier (ID), the operator details related to assignment of the historical tickets (222) and the creation time of the historical tickets (222) and the like.

The other data (226) may store data, including temporary data and temporary files generated by modules for performing the various functions of the incident prediction system (102).

In some embodiments, the data (202) may be processed by the one or more modules (204) of the incident prediction system (102). In an implementation, the one or more modules (204) may include, without limiting to, a training module (228), a receiving module (230), an identifying module (232), a word identification module (234), a cluster identification module (236), a sequence rule identification module (238), a risk score prediction module (240)) and other modules (242). In an embodiment, the other modules (242) may be used to perform various miscellaneous functionalities of the incident prediction system (102). It will be appreciated that such one or more modules (204) may be represented as a single module or a combination of different modules.

In some embodiments, the training module (228) is configured to train the one or more models (224) for predicting the catastrophic incidents in the service system.

In some embodiments, the training module (228) may be configured to collect the one or more training parameters of a plurality of historical tickets (222) for the one or more services associated with the service systems, from the one or more sources (104).

In some embodiments, upon collecting the one or more training parameters, associated with the plurality of historical tickets (222), the training module (228) may be configured to segregate the plurality of historical tickets (222) with respect to the one or more services based on type of service information present in the plurality of historical tickets (222). For example, software maintenance in a deployment system, attendance marking in an ERP system, and the like.

Upon segregating the plurality of historical tickets (222), the training module (228) may be configured to chronologically align the segregated plurality of historical tickets (222) based on a creation time of the plurality of historical tickets (222) for each service.

Further, the training module (228) may be configured to identify a set of historical tickets corresponding to a pre-defined event window and a pre-defined non-event window for each service of the one or more services, from the plurality of historical tickets (222). The event window is defined as a time period comprising the historical tickets (222) occurring prior to occurrence of high severity historical tickets and the non-event window is defined as a time period comprising the historical tickets (222) occurring prior to occurrence of low severity historical tickets, respectively. The time period for the event window and/or the non-event window may be determined based on inter-arrival time of the plurality of historical tickets (222). The inter-arrival time may indicate frequency of logging of the historical tickets (222). Furthermore, the training module (228) may be configured to filter out the high severity historical tickets and the low severity historical tickets from the plurality of historical tickets (222). Thereafter, the training module (228) may be configured to calculate an inter-arrival time for each of the high severity historical tickets and the low severity historical tickets. The training module (228) may calculate the inter-arrival time by averaging time gap of the occurrence of the high severity historical tickets and the low severity historical tickets by utilizing creation information associated with the plurality of the historical tickets (222).

In some embodiments, the training module (228) may be configured to identify the set of historical tickets by removing concurrently occurring historical tickets for each service. In an embodiment, the concurrently occurring historical tickets are type of tickets belonging to failure window. The type of tickets belonging to the failure window may need to be removed as they may include residual effect of the failure because of buffer time post occurrence of any high severity historical tickets.

Upon identifying the set of historical tickets, the training module (228) may be configured to train a prediction model to identify the set of words for each of the set of historical tickets for each service based on the one or more training parameters corresponding to each of the set of historical tickets using the NLP techniques as described below. The training module (228) may perform text-preprocessing based on the ticket description of the historical tickets (222). Particularly, the training module (228) may be configured to process ticket description by removing unrelated terms. In some embodiments, the unrelated terms may be selected based testing and validation of the one or more tickets. In some other embodiments, the unrelated terms may be provided manually by the domain experts and may be stored in the one or more sources (104). In an embodiment, the unrelated terms may be standard terms which are relevant across all services. In an embodiment, the unrelated terms may be exclusive which are specific to a particular service. In some other embodiment, the unrelated terms may be a mixture of the standard type and exclusive type of unrelated terms. Upon removal of the unrelated terms in the ticket description, the training module (228) may be configured to process the ticket description using lemmatization and tokenization to obtain the set of words. Thereafter, the training module (228) may be configured to perform vectorization on the set of words to determine significant information associated with the set of tickets.

Upon identifying the set of words, the training module (228) may be configured to train a ticket clustering model to generate training clusters from the set of words corresponding to the set of historical tickets for each service. Particularly, the training module (228) may process the set of words using one or more calculations such as, a cosine distance calculation to determine cosine similarity score of the set of words. In some instances, the cosine similarity score may provide similarities of words in the set of words. Further, the training module (228) may be configured to cluster the set of words using one or more clustering techniques to determine the cosine similarity score. In some embodiments, a Euclidean distance may also be determined instead of the cosine similarity score. In one embodiment, the one or more clustering technique may include, but not limited to, k-means clustering technique. In some embodiments, the training module (228) may obtain optimum training clusters by processing a variety of metrics such as Akaike Information Criterion (AIC), distortion, and the like. The training clusters may be utilized to determine cluster data (212) in real-time.

Further, the training module (228) may be configured to train a mining model to generate training sequence rules based on chronological patterns of the training clusters impacting occurrence of the high severity historical tickets, for each service, using one or more mining techniques. The training sequence rules may also be referred as the predefined sequence rules. The one or more mining techniques may include, but not limited to, association mining techniques. Particularly, the training module (228) may be configured to utilize the association mining techniques to select training sequence rules based on pre-defined set of support, confidence, and lift values. The set of support may measure frequency of occurrence of a rule in occurrence and non-occurrence of the high severity incident. In an embodiment, rules with low support may indicate co-occurring pattern which may have occurred by chance. The pre-defined confidence may provide predictability value of the high severity incident from the sequence rule. The lift value measures the proportion of time that the high severity incident occurred given a particular rule occurred. The selected sequence rules may incident at least one of, a main interaction effect, a second-degree interaction effect and a third-degree interaction effect. In an embodiment, the training sequence rules associated with the main interaction effect may provide significant indicators based on occurrence and non-occurrence of the high severity historical tickets. In some embodiments, the training sequence rules associated with the second-degree interaction effect and the third-degree interaction effect may provide a chain of cluster combinations. The chain of cluster combinations may indicate occurrence and non-occurrence of the high severity historical tickets if they appear in the identified chronological order. For example, consider three sequence rules R1, R2 and R3. Further, consider a base risk score is 20%. Then in such a case, upon analysis of R1, the main interaction effect for R1 is 30%-20%=10%. Further, upon analysis of R2, the main interaction effect for R2 is 25%-20%=5%. Further, upon analysis of R3, the main interaction effect for R3 is 35%-20%=15%. Further, in some instances if both R1 and R2 occur simultaneously, the risk score may rise up to 50%. Since, sum of main effects of R1 and R2 with the base risk is only 35% (=20%+10%+5%), the rest 15% is the interaction effect of R1 and R2. In some other instances, if both R1 and R3 occur simultaneously, the risk score may rise up to 45%. Since, sum of main effects of R1 and R3 with the base risk is only 35% (=20%+10%+5%), the rest 10% is the interaction effect of R1 and R3. Further, in some other instances, if all the three sequences R1, R2 & R3 are analyzed, then the risk score goes up to 90%. The sum of main effects of R1, R2 & R3 with the base risk is 50% (=20%+10%+5%+15%). The interaction effect of R1 & R2 allots 15%, interaction effect of R1 & R3 adds another 10% and interaction effect of R2 & R3 adds a further 5%. Thus, all 2nd degree interaction effects add 30% (=15%+10%+5%). Thus, the rest 10% (=90%-50%-30%) is the interaction effect of R1, R2 & R3.

In some embodiments, the training module (228) may be configured to train the prediction model to generate the impact scores (220) for identifying the training sequence rules using a predefined machine learning technique. The impact scores (220) is indicative of a value of each of the trained sequence rules for promoting or demoting the occurrence of the high severity historical tickets. The predefined machine learning technique may include, but not limited to, a Naive-Bayes classifier. The training module (228) may utilize the Naive-Bayes classifier to estimate the impact scores (220) of each of the training sequence rules in promoting or demoting the occurrence of the high severity historical tickets by creating a classification scenario for the set of historical tickets. The impact score (220) may also be referred as the predefined impact score.

In some embodiments, the training module (228) may be configured to calculate a hazard rate for the set of historical tickets based on the inter-arrival time of the historical tickets (222). The inter-arrival time provides information on expected time to failure associated with the historical tickets (222).

Upon training the one or more models (224), the incident prediction system (102) may be configured to determine the catastrophic incidents for the one or more tickets in real-time.

In some embodiments, the receiving module (230) may be configured to receive the one or more tickets associated with the service system along with information of each of the one or more tickets, from the one or more sources (104).

In some embodiments, the identifying module (232) may be configured to segregate the one or more tickets with respect to the one or more services and chronologically align the segregated one or more tickets based on the creation time of the one or more tickets.

In some embodiments, the identifying module (232) may be configured to identify the set of tickets for each of the predefined event window and the predefined non-event window from the one or more tickets, for each of the one or more services. In some embodiments, the identifying module (232) may identify the set of tickets by removing concurrently occurring tickets in the predefined event window and the predefined non-event window.

In some embodiments, the word identification module (234) may be configured to identify the set of words for each of the set of tickets, for each of the predefined event window and the predefined non-event window, based on the information corresponding to the respective set of tickets using the prediction model as described below. Firstly, the word identification module (234) may be configured to obtain the ticket description based on the information corresponding to each of the set of tickets. Furthermore, the word identification module (234) may be configured to remove unrelated terms in the ticket description of the set of tickets using the NLP techniques. The NLP techniques may include, but is not limited to lemmatization, tokenization and vectorization. In some instances, the unrelated terms may be selected based on testing and validation of the one or more tickets and may be pre-stored in the one or more sources (104). In some other embodiments, the unrelated terms may also be provided manually by the domain experts and may be pre-stored in the one or more sources (104). In some instances, the unrelated terms may be standard which are relevant across all services. In some other instances, the unrelated terms may be exclusive which are specific to a particular service. In some other instances, the unrelated terms may be a mixture of the standard type and the exclusive type of unrelated terms. Upon removal of the unrelated terms in the ticket description, the word identification module (234) may be configured to process the ticket description using lemmatization, and tokenization to obtain the set of words. In some embodiments, the word identification module (234) may be configured to perform vectorization on the set of words to provide significant information associated with the set of tickets. In some embodiments, lemmatization may be utilized to determine words of significance related to the set of tickets. For example, in one of the ticket descriptions to determine the ticket is of high severity, significant words are based on logging issue, maintenance issue, and the like.

In some embodiments, the cluster identification module (236) may be configured to identify the cluster data (212) from pre-defined clusters by correlating information associated with the pre-defined clusters with the set of words respective to each of the set of tickets using the ticket clustering model, using one or more clustering techniques as described below. The one or more clustering techniques may include but not limited to, k-means clustering techniques. The pre-defined clusters may also be referred to as training clusters as described above. The cluster identification module (236) correlates the information associated with the pre-defined clusters by calculating a pair-wise cosine distance for each of the set of words with centroids of each of the pre-defined clusters. Further, the cluster identification module (236) may be configured to determine minimum cosine distance from the pair-wise cosine distance for each of the set of words with the centroids of each of the pre-defined clusters. Thereafter, the cluster identification module (236) may be configured to identify the cluster data (212) from the pre-defined clusters based on the minimum cosine distance.

In some embodiments, the sequence rule identification module (238) may be configured to identify presence of the one or more sequence rules (214) in the cluster data (212) for each of the set of tickets based on occurrence of one or more predefined patterns corresponding to predefined sequence rules based on information of the pre-defined clusters using the trained mining model. In some instances, the one or more predefined pattern may include, but not limited to, cluster chain patterns. For example, as described above the first cluster includes the set of tickets leading to the high severity incidents. Then in such cases, the sequence rules (214) may include sequence ABDF which may be determined to cause the high severity incidents. Similarly, in some other instances, the sequence rules (214) may include sequence DEFG which may be determined to cause the low severity incidents.

In some embodiments the risk score prediction module (240) may be configured to generate the risk score (216) for each of the one or more services and the one or more root-causes (218) for the set of tickets based on the one or more sequence rules (214), one or more parameters of historical tickets (222) and creation time of the one or more tickets as described below. The risk score prediction module (240) may be configured to generate the risk score (216) based on a function of the hazard rate of each service based on the set of tickets, identified time elapsed and the impact scores for the set of tickets. The catastrophic incidents are predicted based on the risk score (216) and the one or more root-causes (218). The following are the steps to generate the risk score (216). Firstly, the risk score prediction module (240) may be configured to obtain the hazard rate calculated at the training period. Further, the risk score prediction module (240) may be configured to identify the time elapsed since last occurrence of high severity ticket for each service based on creation time of the set of tickets. Further, the risk score prediction module (240) may be configured to identify the impact scores corresponding to each of the one or more sequence rules (214) from the predefined impact scores associated with the predefined sequence rules. The predefined impact scores and the predefined sequence rules are associated with the historical tickets (222) and are determined at the time of training of the one or more models (224). Thereafter, the risk score prediction module (240) may be configured to generate the risk score (216) based on a function of the hazard rate, the identified time elapsed and the impact scores. In some embodiments, the function may include, but not limited to, multiplication.

In some embodiments, the possible root-causes (218) may be based on the identified sequence rules (214). In one example, the root-causes (218) for the high severity ticket may be due to system failure which may have been caused because of an outdated system due to lack of updating the system for 6 months. In another example, the root-causes (218) for the low severity ticket may be due to regular maintenance issues while upgrading software in the ERP system.

The process of predicting the catastrophic incidents is explained with the help of one or more examples for better understanding of the present disclosure. However, the one or more examples should not be considered as limitation of the present disclosure.

Consider an exemplary scenario wherein the one or more tickets for an ERP system is collected along with information of the tickets from a ticket database. For instance, the tickets may include ticket A, ticket B, ticket C and ticket D. Herein, information of the ticket A includes identification number, which is five, type of service which is attendance marking system, issue is related to not being able to mark attendance for more than fifteen days because of which salary is being deducted, complaint Identifier (ID) is four, the creation time of the ticket A in 7 Dec. 2022 at 5:30 pm. In the case of the ticket B, which is also related to the ERP system. The information of the ticket B comprises identification number of the ticket B, which is seven, the type of service is attendance marking system, issue is related to not being able to mark the attendance for two days, complaint Identifier (ID) is six, the creation time of the one or more tickets may be 3 Jan. 2023 at 3:30 pm. Similar type of information is associated with the ticket C and the ticket D. In such scenario, the ticket A is identified as a high severity ticket, the ticket B is identified as a low severity ticket, the ticket C is identified as a medium severity ticket and the ticket D is removed due to concurrent occurrence in the event window and non-event window. Further, a set of words are identified for each of the ticket A, ticket B and ticket C. Based on the set of words, the cluster data (212) may be identified for each of ticket A, ticket B and ticket C. In the case of the ticket A, the one or more sequence rules (214) determined are cutover activity issues, network change issues, and return code: 49 issue. In the case of ticket B, the one or more sequences rules are network change issues. Further, in the case of ticket C, the one or more sequence rules (214) determined are system failure issues, network change issues, and the like. Based on the predefined sequence rules at the training time, the incident prediction system (102) identifies the sequence rules (214) generated after occurrence of ticket A for a service line and the impact score for the said sequences.

Consider, the impact scores are very high and the occurrence of last high severity ticket for said service line is nine hours back. Consider, based on the impact score and the last occurrence of event, the risk score (216) is determined to be 80%. This determined risk score (216) is notified to the respective personnel via a User Interface (UI) associated with the one or more user devices of the respective personnel. Thereafter, upon rectifying issues associated with the most impactful ticket generated till ticket A, the risk score (216) may automatically get updated to for instance, 40% and a catastrophic incident is avoided. FIG. 3A-3C shows exemplary UI representations (300A-300C) for predicting catastrophic incidents in service system.

FIG. 3A depicts various services, associated risk score and probability of risk of failure leading to the catastrophic incident. For instance, as shown, Infra-server backup service has a 72% risk of failure. Infra server job service has a 43% risk of failure. Similarly, Infra network service, infra network device service and infra cluster service incidents a 30%, 26% and 16% risk failure, respectively. In some embodiments, medium impact may also be referenced as a medium severity incident. As depicted in the FIG. 3A-C, it is inferred that the risk score is 80%. A detailed example of an incident related to infra server monitoring is depicted in FIG. 3B. In this case, it is inferred that the risk score is 80% for the infra server monitoring and may lead to a catastrophic incident in the next 24 to 35 hours. A detailed explanation of health of the incident related to infra server monitoring is depicted in the FIG. 3C. According to FIG. 3C, out of ten tickets, eight are open tickets, one ticket is a work in progress ticket and one ticket is a closed ticket. Herein, an inference is provided that one open ticket is overdue and three open tickets are of high severity. If the aforementioned four tickets are not resolved, an incident ABC as shown in FIG. 3C may lead to the catastrophic incident.

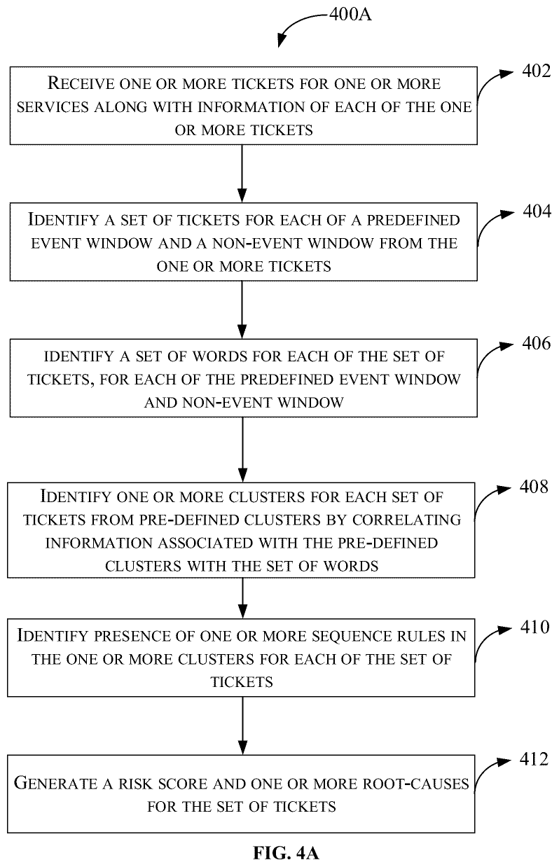

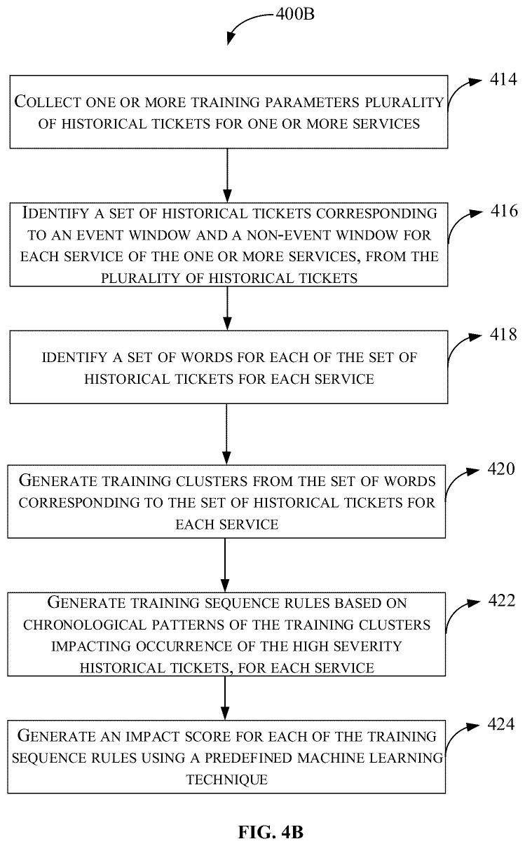

FIG. 4A shows a flowchart illustrating a method (400A) for predicting catastrophic incidents in a service system, in accordance with some embodiments of the present disclosure.

As illustrated in FIG. 4A, the method (400A) may include one or more blocks illustrating a method for predicting the catastrophic incidents using an incident prediction system (102) illustrated in FIG. 2. The method (400A) may be described in the general context of computer executable instructions. Generally, computer executable instructions can include routines, programs, objects, components, data structures, procedures, modules, and functions, which perform specific functions or implement specific abstract data types.

The order in which the method (400A) is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 402, the method (400A) includes receiving, by a processor (106), one or more tickets for one or more services associated with the service system along with information of each of the one or more tickets, from one or more sources (104).

At block 404, the method (400A) includes identifying, by the processor (106), a set of tickets for each of a predefined window and a predefined non-event window from the one or more tickets, for each of the one or more services.

At block 406, the method (400A) includes identifying, by the processor (106), a set of words for each of the set of tickets, for each of the predefined event window and the predefined non-event window, based on the information corresponding to the respective set of tickets using a prediction model.

At block 408, the method (400A) includes identifying, by the processor (106), cluster data (212) for each set of tickets from pre-defined clusters by correlating information associated with the pre-defined clusters with the set of words respective to each of the set of tickets, using a ticket clustering model.

At block 410, the method (400A) includes identifying, by the processor (106), presence of one or more sequence rules (214) in cluster data (212) for each of the set of tickets based on occurrence of one or more predefined patterns corresponding to predefined sequence rules.

At block 412, the method (400A) includes generating, by the processor (106), a risk score (216) for each of the one or more services and one or more root-causes (218) for the set of tickets based on the one or more sequence rules (214), one or more parameters of historical tickets (222) and creation time of the one or more tickets. The catastrophic incidents are predicted based on the risk score (216) and the one or more root-causes (218).

FIG. 4B shows a flowchart illustrating a method (400B) for training models for predicting catastrophic incidents in a service system, in accordance with some embodiments of the present disclosure.

As illustrated in FIG. 4B, the method (400B) may include one or more blocks illustrating a method for training one or more models (224) for predicting the catastrophic incidents in the service system. The method (400B) may be described in the general context of computer executable instructions. Generally, computer executable instructions can include routines, programs, objects, components, data structures, procedures, modules, and functions, which perform specific functions or implement specific abstract data types.

At block 414, the method (400B) includes collecting, by the processor (106), one or more training parameters of a plurality of historical tickets (222) for one or more services associated with the service systems, from one or more sources (104).

At block 416, the method (400B) includes identifying, by the processor (106), a set of historical tickets corresponding to an event window and a non-event window for each service of the one or more services, from the plurality of historical tickets (222) The set of historical tickets comprises high severity historical tickets and low severity historical tickets.

At block 418, the method (400B) includes identifying, by the processor (106), a set of words for each of the set of historical tickets for each service based on the one or more training parameters corresponding to each set of historical tickets using Natural Language Processing (NLP) techniques.

At block 420, the method (400B) includes generating, by the processor (106), training clusters from the set of words corresponding to the set of historical tickets for each service.

At block 422, the method (400B) includes generating, by the processor (106), training sequence rules based on chronological patterns of the training clusters impacting occurrence of the high severity historical tickets, for each service, using one or more mining techniques.

At block 424, the method (400B) includes generating, by the processor (106), an impact score (220) for each of the training sequence rules using a predefined machine learning technique. The impact scores (220) is indicative of a value of each of the trained sequence rules for promoting or demoting the occurrence of the high severity historical tickets.

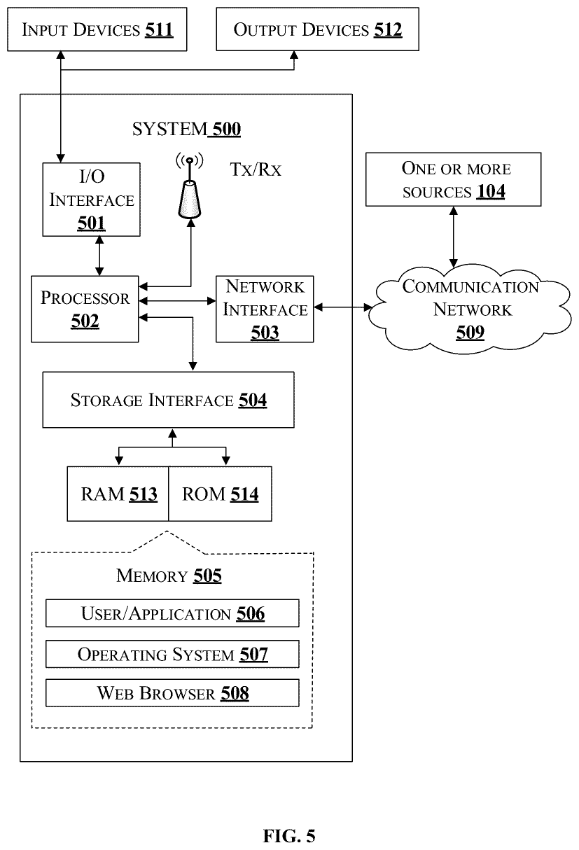

FIG. 5 illustrates a block diagram of an exemplary computer system (500) for implementing embodiments consistent with the present disclosure.

In an embodiment, the computer system (500) may be an incident prediction system (102) illustrated in FIG. 2, which may be used for predicting catastrophic incidents. The computer system (500) may include a central processing unit (“CPU” or “processor” or “memory controller”) (502). The processor (502) may comprise at least one data processor for executing program components for executing user- or system-generated business processes. The processor (502) may include specialized processing units such as integrated system (bus) controllers, memory controllers/memory management control units, floating point units, graphics processing units, digital signal processing units, etc.

The processor (502) may be disposed in communication with one or more Input/Output (I/O) devices (511) and (512) via I/O interface (501). The I/O interface (501) may employ communication protocols/methods such as, without limitation, audio, analog, digital, stereo, IEEE®-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE® 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc. Using the I/O interface (501), the computer system (500) may communicate with one or more I/O devices (511) and (512).

In some embodiments, the processor (502) may be disposed in communication with a communication network (509) via a network interface (503). The network interface (503) may communicate with the communication network (509). The network interface (503) may employ connection protocols including, without limitation, direct connect, Ethernet (e.g., twisted pair 10/100/1000 Base T), Transmission Control Protocol/Internet Protocol (TCP/IP), token ring, IEEE® 802.11a/b/g/n/x, etc.

In an implementation, the communication network (509) may be implemented as one of the several types of networks, such as intranet or Local Area Network (LAN) and such within the organization. The communication network (509) may either be a dedicated network or a shared network, which represents an association of several types of networks that use a variety of protocols, for example, Hypertext Transfer Protocol (HTTP), Transmission Control Protocol/Internet Protocol (TCP/IP), Wireless Application Protocol (WAP) etc., to communicate with each other. Further, the communication network (509) may include a variety of network devices, including routers, bridges, servers, computing devices, storage devices, etc. In an embodiment, the communication network (509) may be used for interfacing with one or more sources (104) for receiving one or more tickets.

In some embodiments, the processor (502) may be disposed in communication with a memory (505) (e.g., RAM (513), ROM (514), etc. as shown in FIG. 5) via a storage interface (504). The storage interface (504) may connect to memory (505) including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory (505) may store a collection of program or database components, including, without limitation, user/application interface (506), an operating system (507), a web browser (508), and the like. In some embodiments, the computer system (500) may store user/application data (506), such as the data, variables, records, etc. as described in this invention. Such databases may be implemented as fault-tolerant, relational, scalable, secure databases such as Oracle® or Sybase®.

The operating system (507) may facilitate resource management and operation of the computer system (500). Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM® OS/2R MICROSOFT® WINDOWS® (XP®, VISTA®/7/8, 10 etc.), APPLE® IOS®, GOOGLE IM ANDROID™, BLACKBERRY® OS, or the like.

The user interface (506) may facilitate display, execution, interaction, manipulation, or operation of program components through textual or graphical facilities. For example, the user interface (506) may provide computer interaction interface elements on a display system operatively connected to the computer system (500), such as cursors, icons, check boxes, menus, scrollers, windows, widgets, and the like. Further. Graphical User Interfaces (GUIs) may be employed, including, without limitation. APPLE® MACINTOSH® operating systems' Aqua®. IBM® OS/2®. MICROSOFT® WINDOWS® (e.g., Aero. Metro, etc.), web interface libraries (e.g., ActiveX®, JAVA®, JAVASCRIPT®, AJAX, HTML, ADOBE® FLASH®, etc.), or the like.

The web browser (508) may be a hypertext viewing application. Secure web browsing may be provided using Secure Hypertext Transport Protocol (HTTPS). Secure Sockets Layer (SSL). Transport Layer Security (TLS), and the like. The web browsers (508) may utilize facilities such as AJAX, DHTML, ADOBE® FLASH®, JAVASCRIPT®, JAVA®, Application Programming Interfaces (APIs), and the like. Further, the computer system (500) may implement a mail server stored program component. The mail server may utilize facilities such as ASP. ACTIVEX®, ANSI® C++/C#, MICROSOFT®, .NET, CGI SCRIPTS, JAVAR®, JAVASCRIPT®, PERL®, PHP, PYTHON®, WEBOBJECTS®, etc. The mail server may utilize communication protocols such as Internet Message Access Protocol (IMAP). Messaging Application Programming Interface (MAPI), MICROSOFT® exchange. Post Office Protocol (POP). Simple Mail Transfer Protocol (SMTP), or the like. In some embodiments, the computer system (500) may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, and the like.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals. i.e., non-transitory. Examples include Random Access Memory (RAM), Read-Only Memory (ROM), volatile memory, nonvolatile memory, hard drives. Compact Disc (CD) ROMs, Digital Video Disc (DVDs), flash drives, disks, and any other known physical storage media.

In an embodiment, the present disclosure provides an incident prediction system and a method for predicting catastrophic incidents in a service system. To overcome the technical problems related to predicting the catastrophic incidents, the disclosed system and method aims to provide a machine learning based approach to predict future occurrences of high severity incidents for each service in the service system by predicting a risk score along with possible root-causes of the high severity incidents ahead of occurrence of the catastrophic incidents. For instance, if the risk score is determined to be high, the present disclosure provides an alert to an IT management system to prioritize tickets accordingly and fix the catastrophic incidents ahead to avoid disruptive disturbance in the IT management system. In some embodiments, the IT management system may also be referred to as the service system. Further, the present disclosure aims to provide a path to utilize historical tickets and one or more tickets to detect complex recurring patterns of the catastrophic incidents and the historical tickets may be trained to alert the catastrophic incidents proactively before those catastrophic incidents occur. In an embodiment, the present disclosure aims to identify recurring patterns because of identification of the root-causes associated with high severity tickets and creates proactive guidelines. These proactive guidelines may be utilized once these recurring patterns are detected in order to reduce workload of resources and enhance utilization rate.

Currently, for predicting the catastrophic incidents and for determining the root-causes associated with the catastrophic incidents, the existing systems do not include a mechanism to identify the catastrophic incidents for multiple services based on individual patterns and may not consider sequence of events for root cause identification with respect to the catastrophic incident.

In an embodiment, the present disclosure identifies recurring patterns and creates proactive guidelines which may be utilized once these recurring patterns are detected in order to reduce workload of resources and enhance utilization rate.

As stated above, it shall be noted that the method of the present disclosure may be used to overcome various technical problems related to predicting catastrophic incidents. In other words, the disclosed method has a practical application and provides a technically advanced solution to the technical problems associated with the existing catastrophic prediction system.

In light of the above-mentioned advantages and the technical advancements provided by the disclosed system and method, the claimed steps as discussed above are not routine, conventional, or well understood in the art, as the claimed steps enable the following solutions to the existing problems in conventional technologies. Further, the claimed steps clearly bring an improvement in the functioning of the system itself as the claimed steps provide a technical solution to a technical problem.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device/article is described herein (whether they cooperate), it will be clear that a single device/article may be used in place of the more than one device/article, or a different number of devices/articles may be used instead of the shown number of devices or programs. The functionality and/or features of a device may be alternatively embodied by one or more other devices which are not explicitly described as having such functionality/features. Thus, other embodiments of invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERENCE NUMERALS

| Reference | |
|---|---|
| Number | Description |
| 100 | Environment of an incident prediction system |
| 102 | Incident prediction system |
| 104 | One or more sources |
| 106 | Processor |
| 108 | I/O interface |
| 110 | Memory |
| 112 | Communication network |
| 202 | Data |
| 204 | One or more modules |
| 206 | Ticket data |
| 208 | Event window data |
| 210 | Non-event window data |
| 212 | Cluster data |
| 214 | Sequence rules |
| 216 | Risk score |
| 218 | Root-causes |
| 220 | Impact scores |
| 222 | Historical tickets |
| 224 | One or more models |
| 226 | Other data |
| 228 | Training module |
| 230 | Receiving module |
| 232 | Identifying module |
| 234 | Word identification module |
| 236 | Cluster identification module |
| 238 | Sequence rule generation module |
| 240 | Risk score prediction module |
| 242 | Other modules |
| 500 | Exemplary computer system |
| 501 | I/O Interface of the exemplary computer system |
| 502 | Processor of the exemplary computer system |
| 503 | Network interface |
| 504 | Storage interface |
| 505 | Memory of the exemplary computer system |
| 506 | User/Application |
| 507 | Operating system |
| 508 | Web browser |
| 509 | Communication network |
| 511 | Input devices |
| 512 | Output devices |
| 513 | RAM |
| 514 | ROM |

What is claimed is:

1. A method of predicting catastrophic incidents in a service system, the method comprising:
receiving, by a processor of an incident prediction system, one or more tickets for one or more services associated with the service system along with information of each of the one or more tickets, from one or more sources;
identifying, by the processor, a set of tickets for each of a predefined event window and a predefined non-event window from the one or more tickets, for each of the one or more services, wherein the predefined event window and the predefined non-event window are each indicative of a time period comprising the set of tickets occurring prior to occurrence of high severity tickets and low severity tickets, respectively;
identifying, by the processor, a set of words for each of the set of tickets, for each of the predefined event window and the predefined non-event window, based on the information corresponding to the respective set of tickets using a prediction model;
identifying, by the processor, cluster data for each set of tickets from pre-defined clusters by correlating information associated with the pre-defined clusters with the set of words respective to each of the set of tickets, using a ticket clustering model;
identifying, by the processor, presence of one or more sequence rules in the cluster data for each of the set of tickets based on occurrence of one or more predefined patterns corresponding to predefined sequence rules using a mining model; and
generating, by the processor, a risk score for each of the one or more services and one or more root-causes for the set of tickets based on the one or more sequence rules, one or more parameters of historical tickets and creation time of the one or more tickets, wherein the catastrophic incidents is predicted based on the risk score and the one or more root-causes.

2. The method as claimed in claim 1, wherein upon receiving the one or more tickets, the method comprises:
segregating the one or more tickets with respect to the one or more services; and
chronologically aligning the segregated one or more tickets based on the creation time of the one or more tickets.

3. The method as claimed in claim 1, wherein the information of the one or more tickets comprises severity information of the one or more tickets, identification number of ticket, type of service associated with the one or more tickets, ticket description, complaint Identifier (ID), operator details related to assignment of ticket and the creation time of the one or more tickets.

4. The method as claimed in claim 1, wherein identifying the set of tickets for each of the predefined event window and the predefined non-event window comprises:
removing tickets occurring concurrently in the predefined event window and the predefined non-event window and,
wherein identifying the set of words for each of the set of tickets comprise:
obtaining ticket description based on the information corresponding to each of the set of tickets;
identifying unrelated terms in the ticket description of the set of tickets using Natural Language Processing (NLP) technique, wherein the identified unrelated terms are removed from associated ticket description of the set of tickets; and
obtaining the set of words for each of the set of tickets by processing respective ticket description using the NLP techniques.

5. The method as claimed in claim 1, wherein correlating the information associated with the pre-defined clusters with the set of words respective to each of the set of tickets comprise:
calculating a pair-wise cosine distance for each of the set of words with centroids of each of the pre-defined clusters;
determining minimum cosine distance from the pair-wise cosine distance for each of the set of words with the centroids of each of the pre-defined clusters; and
identifying a cluster from the pre-defined clusters based on the minimum cosine distance.

6. The method as claimed in claim 1, wherein the pre-defined sequence rules are generated using a mining model based on the information of the pre-defined clusters.

7. The method as claimed in claim 1, wherein the one or more parameters of the historical tickets comprise a hazard rate for the historical tickets, inter-arrival time of historical tickets and severity information of the historical tickets.

8. The method as claimed in claim 1, wherein generating the risk score based on the one or more parameters of the historical tickets comprises:
identifying time elapsed from last occurrence of the high severity ticket based on the creation time of the one or more tickets;
identifying impact scores corresponding to each of the one or more sequence rules from predefined impact scores associated with the predefined sequence rules; and
generating the risk score based on a function of a hazard rate determined based on an inter-arrival time for the historical tickets, the identified time elapsed and the impact scores.

9. A method for training one or more models for predicting catastrophic incidents in a service system, the method comprising:
collecting, by an incident prediction system, one or more training parameters of a plurality of historical tickets for one or more services associated with the service systems, from one or more sources;
identifying, by the incident prediction system, a set of historical tickets corresponding to an event window and a non-event window for each service of the one or more services, from the plurality of historical tickets, wherein the set of historical tickets comprises high severity historical tickets and low severity historical tickets, and wherein the event window and the non-event window are each indicative of a time period comprising historical tickets occurring prior to occurrence of the high severity historical tickets and the low severity historical tickets respectively, and wherein the time period is determined based on an inter-arrival time of the plurality of historical tickets;
identifying, by the incident prediction system, a set of words for each of the set of historical tickets for each service based on the one or more training parameters corresponding to each set of historical tickets using Natural Language Processing (NLP) techniques;
generating, by the incident prediction system, training clusters from the set of words corresponding to the set of historical tickets for each service;
generating, by the incident prediction system, training sequence rules based on chronological patterns of the training clusters impacting occurrence of the high severity historical tickets, for each service, using one or more mining techniques; and
generating, by the incident prediction system, an impact score for each of the training sequence rules using a predefined machine learning technique, wherein the impact scores is indicative of a value of each of the trained sequence rules for promoting or demoting the occurrence of the high severity historical tickets.

10. The method as claimed in claim 9, wherein upon collecting the one or more training parameters of the plurality of historical tickets, the method comprises:
segregating the plurality of historical tickets with respect to the one or more services; and
chronologically aligning the segregated plurality of historical tickets based on a creation time of the plurality of historical tickets for each service.

11. An incident prediction system for predicting catastrophic incidents in a service system, the incident prediction system comprises:
a processor:
a memory, communicatively coupled to the processor, wherein the memory stores instructions, which, on execution, cause the processor to:
receive one or more tickets for one or more services associated with the service system along with information of each of the one or more tickets, from one or more sources:
identify a set of tickets for each of a predefined event window and a predefined non-event window from the one or more tickets, for each of the one or more services, wherein the predefined event window and the predefined non-event window are each indicative of a time period comprising the set of tickets occurring prior to occurrence of high severity tickets and low severity tickets, respectively:
identify a set of words for each of the set of tickets, for each of the predefined event window and the predefined non-event window, based on the information corresponding to the respective set of tickets using a prediction model;
identify cluster data for each set of tickets from pre-defined clusters by correlating information associated with the pre-defined clusters with the set of words respective to each of the set of tickets, using a ticket clustering model:
identify presence of one or more sequence rules in the cluster data for each of the set of tickets based on occurrence of one or more predefined patterns corresponding to predefined sequence rules using a mining model; and
generate a risk score for each of the one or more services and one or more root-causes for the set of tickets based on the one or more sequence rules, one or more parameters of historical tickets and creation time of the one or more tickets, wherein the catastrophic incidents is predicted based on the risk score and the one or more root-causes.

12. The incident prediction system as claimed in claim 11, wherein upon receiving the one or more tickets, the processor is configured to:
segregate the one or more tickets with respect to the one or more services; and
chronologically align the segregated one or more tickets based on the creation time of the one or more tickets.

13. The incident prediction system as claimed in claim 11, wherein the information of the one or more tickets comprises severity information of the one or more tickets, identification number of ticket, type of service associated with the one or more tickets, ticket description, complaint Identifier (ID), operator details related to assignment of ticket and the creation time of the one or more tickets.

14. The incident prediction system as claimed in claim 11, wherein to identify the set of tickets for each of the predefined event window and the predefined non-event window the processor is configured to:
remove tickets occurring concurrently in the predefined event window and the predefined non-event window and,
wherein to identify the set of words for each of the set of tickets, the processor is configured to:
obtain ticket description based on the information corresponding to each of the set of tickets;
identify unrelated terms in the ticket description of the set of tickets using Natural Language Processing (NLP) technique, wherein the identified unrelated terms are removed from associated ticket description of the set of tickets; and
obtain the set of words for each of the set of tickets by processing respective ticket description using the NLP techniques.

15. The incident prediction system as claimed in claim 11, wherein to correlate the information associated with the pre-defined clusters with the set of words respective to each of the set of tickets, the processor is configured to:
calculate a pair-wise cosine distance for each of the set of words with centroids of each of the pre-defined clusters;
determine minimum cosine distance from the pair-wise cosine distance for each of the set of words with the centroids of each of the pre-defined clusters; and
identify the cluster data from the pre-defined clusters based on the minimum cosine distance.

16. The incident prediction system as claimed in claim 11, wherein the processor is configured to generate the pre-defined sequence rules using a mining model based on the information of the pre-defined clusters.

17. The incident prediction system as claimed in claim 11, wherein the one or more parameters of the historical tickets comprise a hazard rate for the historical tickets, inter-arrival time of historical tickets and severity information of the historical tickets.

18. The incident prediction system as claimed in claim 11, wherein to generate the risk score based on the one or more parameters of the historical tickets, the processor is configured to:
identify time elapsed from last occurrence of the high severity ticket based on the creation time of the one or more tickets;
identify impact scores corresponding to each of the one or more sequence rules from predefined impact scores associated with the predefined sequence rules; and
generate the risk score based on a function of a hazard rate determined based on an inter-arrival time for the historical tickets, the identified time elapsed and the impact scores.

19. An incident prediction system for training one or more models for predicting catastrophic incidents in a service system, the incident prediction system comprises:
a processor;
a memory, communicatively coupled to the processor, wherein the memory stores instructions, which, on execution, cause the processor to:
collect one or more training parameters of a plurality of historical tickets for one or more services associated with the service systems, from one or more sources;
identify a set of historical tickets corresponding to an event window and a non-event window for each service of the one or more services, from the plurality of historical tickets, wherein the set of historical tickets comprises high severity historical tickets and low severity historical tickets, and wherein the event window and the non-event window are each indicative of a time period respectively comprising historical tickets occurring prior to occurrence of the high severity historical tickets and the low severity historical tickets, respectively, and wherein the time period is determined based on an inter-arrival time of the plurality of historical tickets;
identify a set of words for each of the set of historical tickets for each service based on the one or more training parameters corresponding to each set of historical tickets using Natural Language Processing (NLP) techniques;
generate training clusters from the set of words corresponding to the set of historical tickets for each service;
generate training sequence rules based on chronological patterns of the training clusters impacting occurrence of the high severity historical tickets, for each service, using one or more mining techniques; and
generate an impact score for each of the training sequence rules using a predefined machine learning technique, wherein the impact scores is indicative of a value of each of the trained sequence rules for promoting or demoting the occurrence of the high severity historical tickets, for each service.

20. The incident prediction system as claimed in claim 19, wherein upon collecting the one or more training parameters of the plurality of historical tickets, the processor is configured to:
segregate the plurality of historical tickets with respect to the one or more services; and
chronologically align the segregated plurality of historical tickets based on a creation time of the plurality of historical tickets for each service.

21. A non-transitory computer readable medium including instruction stored thereon that when processed by at least one processor cause an incident prediction system to perform operation comprising:
receiving one or more tickets for one or more services associated with the service system along with information of each of the one or more tickets, from one or more sources;
identifying a set of tickets for each of a predefined event window and a predefined non-event window from the one or more tickets, for each of the one or more services, wherein the predefined event window and the predefined non-event window are each indicative of a time period comprising the set of tickets occurring prior to occurrence of high severity tickets and low severity tickets, respectively;
identifying a set of words for each of the set of tickets, for each of the predefined event window and the predefined non-event window, based on the information corresponding to the respective set of tickets using a prediction model;
identifying cluster data for each set of tickets from pre-defined clusters by correlating information associated with the pre-defined clusters with the set of words respective to each of the set of tickets, using a ticket clustering model;
identifying presence of one or more sequence rules in the cluster data for each of the set of tickets based on occurrence of one or more predefined patterns corresponding to predefined sequence rules using a mining model; and
generating a risk score for each of the one or more services and one or more root-causes for the set of tickets based on the one or more sequence rules, one or more parameters of historical tickets and creation time of the one or more tickets, wherein the catastrophic incidents is predicted based on the risk score and the one or more root-causes.

22. A non-transitory computer readable medium including instruction stored thereon that when processed by at least one processor cause an incident prediction system to perform operation comprising:
collecting one or more training parameters of a plurality of historical tickets for one or more services associated with the service systems, from one or more sources;
identifying a set of historical tickets corresponding to an event window and a non-event window for each service of the one or more services, from the plurality of historical tickets, wherein the set of historical tickets comprises high severity historical tickets and low severity historical tickets, and wherein the event window and the non-event window are each indicative of a time period comprising historical tickets occurring prior to occurrence of the high severity historical tickets and the low severity historical tickets respectively, and wherein the time period is determined based on an inter-arrival time of the plurality of historical tickets;
identifying a set of words for each of the set of historical tickets for each service based on the one or more training parameters corresponding to each set of historical tickets using Natural Language Processing (NLP) techniques;
generating training clusters from the set of words corresponding to the set of historical tickets for each service;
generating training sequence rules based on chronological patterns of the training clusters impacting occurrence of the high severity historical tickets, for each service, using one or more mining techniques; and
generating an impact score for each of the training sequence rules using a predefined machine learning technique, wherein the impact scores is indicative of a value of each of the trained sequence rules for promoting or demoting the occurrence of the high severity historical tickets.
